(19) United States
(12) Patent Application Publication
(10) Pub. No.: US 2008/0299351 A1
(43) Pub. Date: Dec. 4, 2008

(54) Non-wood building materials with simulated wood-grain surface appearance

(76) Inventors: Walter Scott Buchholtz, Austin, TX (US); James D. Jones, Bay City, TX (US)

Correspondence Address: SCOTT DAVID COMPTON, 2386 South Dairy Ashford Road # 593, Houston, TX, 77077, US

(21) Appl. No.: 11/810,034

(22) Filed: Jun. 4, 2007

(51) Int. Cl. D06N 7/04; B29C 69/00

(52) U.S. Cl. 428/151; 264/238

(57) ABSTRACT

A non-wood building material having a simulated wood-grain appearance of a target natural wood comprising a body defined by an outer surface, the body being formed from a composite material comprising a first amount of a matrix component and a second amount of a filler component; and a third amount of a coloring agent deposited on the outer surface of the body; the outer surface of the body comprising a plurality of grooves configured to (1) expose filler component along the surface of the grooves, and (2) simulate the texture of the target natural wood along the outer surface of the body, the grooves defining an exposed surface of the body; wherein the filler component is present in an amount effective to absorb the coloring agent on the exposed surface in an amount effective for the body to simulate the color of the target natural wood.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE APPLICATION

The present application is related to non-wood building materials that serve as direct replacements for natural wood building materials in various applications.

### BACKGROUND

It has long been appreciated that consumers desire natural wood building materials for applications such as exterior privacy fencing, exterior building trim, and the like. For one, many consumers enjoy natural wood's inherent variability that gives each individual piece of wood a unique aesthetic quality. However, natural wood products may eventually deteriorate from exposure to the elements and/or attack by insects, mold, rot, etc., rendering them aesthetically undesirable and/or structurally unfit for their intended purpose. Treatment materials such as exterior paints and exterior sealers are often used in an attempt to extend the useful lifespan of the natural wood products. Unfortunately, the treatment materials themselves are often expensive and/or toxic to humans and other animals. Likewise, natural wood products are often pressure treated with chemicals that protects the wood from degradation. However, these types of chemicals may be toxic and may leach out of the wood over time.

Thus, various alternatives to natural wood building materials have been developed in an attempt to provide an alternative building material having a longer useful life over that of natural wood. Examples include processed wood materials such as plywood, particle board and wafer board, non-wood materials such as plastics, cements, aluminum and steel, and hybrid materials such as plastics filled with wood fibers or wood flour. However, these types of building materials are distinguishable from natural wood building materials, even from a considerable distance due to surface uniformity and/or unnatural coloring of the building material in an attempt to simulate a natural wood surface appearance.

Hence from the foregoing, it will be appreciated that there is a need for a non-wood building material having a non-uniform simulated wood-grain surface appearance that can be used as a substitute for natural wood applications.

### SUMMARY

The present application provides a non-wood building material having a simulated wood-grain appearance of a target natural wood comprising a body defined by an outer surface, the body being formed from a composite material comprising a first amount of a matrix component and a second amount of a filler component; and a third amount of a coloring agent deposited on the outer surface of the body; the outer surface of the body comprising a plurality of grooves configured to (1) expose filler component along the surface of the grooves, and (2) simulate the texture of the target natural wood along the outer surface of the body, the grooves defining an exposed surface of the body; wherein the filler component is present in an amount effective to absorb the coloring agent on the exposed surface in an amount effective for the body to simulate the color of the target natural wood.

The present application also provides a non-wood building material having a simulated wood-grain appearance of a target natural wood comprising a body defined by an outer surface, the body being formed from a composite material comprising a first amount of a polymer matrix component and a second amount of a filler component of about 9 wt. % or more calcium carbonate; and a third amount of a coloring agent deposited on the outer surface of the body; wherein at least a portion of the outer surface of the body is abraded to expose calcium carbonate in a sub-surface of the body, the abraded portion of the body simulating the texture of the target natural wood; and wherein the coloring agent is absorbed by the calcium carbonate in the sub-surface of the body in an amount effective for the body to simulate the color of the target natural wood.

The present application also provides a method for producing a non-wood building material having a simulated wood-grain appearance of a target natural wood, the method comprising the following steps: providing a body defined by an outer surface, the body being formed from a composite material including (a) a first amount of a polymer matrix component and (b) a second amount of a filler component dispersed throughout the composite material; abrading the outer surface of the body to form a plurality of grooves on the outer surface of the body, exposing filler component on the surface of the grooves; applying a third amount of a coloring agent to the outer surface of the body, wherein the filler component on the surface of the grooves is present in an amount effective to absorb a color simulating amount of the coloring agent; allowing the coloring agent to reside on the outer surface of the body for a time effective for the color simulating amount of the coloring agent to be absorbed into the filler component on the surface of the grooves without the coloring agent being absorbed by the polymer matrix component; and removing a substantial portion of the coloring agent not absorbed into the body.

### BRIEF DESCRIPTION OF THE FIGURES

FIG. 1 illustrates a perspective view of one embodiment of a panel used to produce the non-wood building material.

FIG. 2 illustrates a cross-sectional side view of a panel constructed from a composite material including an outer layer of a matrix component and a first inner layer of the matrix component and one or more filler components.

FIG. 3A illustrates a cross-sectional side view of a panel with a partially hollow core and a plurality of grooves on an outer surface of the panel, some of the grooves penetrating the first inner layer, the panel also including a coloring agent absorbed into the surface of the grooves.

FIG. 3B illustrates a detailed view of a groove on an outer surface of a panel including a coloring agent absorbed into the surface of a portion of the groove penetrating the first inner layer of the panel.

### BRIEF DESCRIPTION

It has been found that a non-wood building material that simulates the wood-grain surface appearance of a target natural wood can be produced from a composite material by manipulating the outer surface of the composite material in a manner effective to (1) simulate the texture of the target natural wood and (2) simulate the color of the target natural wood. Suitably, the composite material comprises one or more filler materials in an amount effective to absorb a coloring agent. In particular, as the outer surface of the composite material is manipulated, a portion of the sub-surface of the composite material is exposed, wherein the exposed sub-surface comprises one or more filler materials in an amount effective to absorb an amount of a coloring agent to produce a non-wood building material that simulates the texture and color of a target natural wood. Heretofore, such a desirable achievement has not been considered possible, and accordingly, the non-wood building material and method of this application measure up to the dignity of patentability and therefore represents a patentable concept.

Before describing the invention in detail, it is to be understood that the present non-wood building material and method are not limited to particular embodiments. It is also to be understood that the terminology used herein is for the purpose of describing particular embodiments only, and is not intended to be limiting. As used in this specification and the appended claims, the phrase “wood-grain appearance” refers to a non-wood building material having the visual appearance, texture, feel, and coloring of a target natural wood. The phrase “non-wood” herein means materials other than natural woods. As described herein, “natural wood products” include but are not necessarily limited to commercially available natural wood products such as fence pickets, wall elements, railings, roof shingles, outer siding, decking, and window frames. The phrase “target natural wood” herein refers to any natural wood to be simulated by the non-wood building material, typical varieties including but not necessarily limited to cedar, oak, redwood, cyprus, cherry, maple, spruce, and walnut. The phrase “color simulating amount” refers to the amount of a coloring agent to be absorbed into a non-wood building material necessary for the non-wood building material to simulate the color of a target natural wood.

In one aspect, the present application provides a non-wood building material that serves as a direct replacement for natural wood building materials in building/construction applications.

In another aspect, the present application provides a non-wood building material that serves as a direct replacement for natural wood building materials in fencing applications.

In another aspect, the present application provides a non-wood building material configured to maintain a simulated wood-grain appearance of a target natural wood for an extended period of time greater than that of the target natural wood.

In another aspect, the present application provides a method for producing a non-wood building material to simulate the wood-grain appearance of a target natural wood.

In another aspect, the present application provides a method for producing a non-wood building material to simulate the wood-grain appearance of a target natural wood including natural wood features such as knot holes and rings.

In another aspect, the present application provides a method of manipulating the outer surface of a composite material to produce a non-wood building material that serves as a direct replacement for a natural wood building material.

In still another aspect, the present application provides an extrusion product made from a composite material, wherein the composite material may be manipulated to simulate the wood-grain appearance of a target natural wood.

In still another aspect, the present application provides a non-wood building material constructed from a composite material including a filler component effective to absorb a coloring agent in an amount effective to produce a non-wood building material that simulates the color of a target natural wood.

In yet another embodiment, the present application provides a method of exposing and treating the sub-surface of an extruded composite material to produce a non-wood building material that simulates the wood-grain appearance of a target natural wood.

In yet another embodiment, the present application provides a method of abrading the surface of an extrusion product to produce a non-wood building material that simulates the wood-grain appearance of a target natural wood.

The various characteristics described above, as well as other features, will now be described with reference to the accompanying drawings, wherein like reference numerals are used for like features throughout the several views. It is to be fully recognized that the different teachings of the embodiments disclosed herein may be employed separately or in any suitable combination to produce desired results.

### DETAILED DESCRIPTION OF THE NON-WOOD BUILDING MATERIAL

The present application presents a non-wood building material produced from a composite material that simulates the wood-grain appearance of a natural wood building material. This is accomplished by providing a non-wood building material comprising at least (1) an original non-wood body (herein referred to as a “panel”) made from a composite material including at least a first amount of a matrix component and a second amount of a filler component in an amount effective to absorb a color simulating amount of a coloring agent, (2) the panel having an outer surface including a plurality of grooves on the surface simulating the texture and appearance of a target natural wood, a portion of the grooves penetrating the surface of the panel to a depth effective to expose a portion of the filler component in the sub-surface, and (3) a coloring agent deposited on the outer surface of the panel wherein the coloring agent is absorbed by the exposed filler component in an amount effective for the non-wood building material to simulate the color of a target natural wood.

Although not limited to a particular size and shape, suitable non-wood building materials may be sized and shaped similar to commercially available natural wood products. For example, a non-wood building material may be produced in a specific size and shape for a particular application, e.g., in the basic form of a fence picket or a border for a window. In the alternative, a non-wood building material may be produced in a nonfunctional size and shape and then further divided, sized and/or shaped by an end user as desired. In addition, the non-wood building material described herein may include irregular shapes such as a tongue and groove configuration.

With reference now to FIG. 1, a simplified panel 10 is provided including a longitudinal axis, an outer surface 11 including a perimeter wall defining opposed end walls, opposed sidewalls, and an interior section there between extending longitudinally through the panel. Suitably, the panel 10 is made from a composite material using conventionally recognized melt processing methods and equipment. Non-limiting examples of melt processing practices include for example, extrusion, injection molding, batch mixing, rotation molding, blow molding, vacuum molding, compression molding, pultrusion or combinations of these processes, as known in the art.

Based on the settling properties of the matrix component and the filler component during melt processing, the panel 10 may include a continuous phase of both matrix component and filler component dispersed throughout the composite material. In the alternative, the panel 10 may include at least (1) an outer layer 12 comprised substantially of a matrix component, and (2) a first inner layer 14 surrounded by the outer layer 12, the first inner layer 14 comprising up to about 100% of the filler component dispersed within the remaining matrix component and forming a continuous phase extending throughout the first inner layer 14.

In one embodiment, the panel 10 may include a solid core. In another embodiment, the panel 10 may include a hollow core, or partially hollow core including individual chambers therein. In still another embodiment, the panel 10 may include a core comprising one or more cavities or cells. In addition, a hollow core, partially hollow core, or the one or more cavities or cells may be effective to reduce the amount of composite material used resulting in a lighter weight non-wood building material. The panel 10 may also be provided with any exterior color on its outer surface. In addition, the interior or sub-surface of the panel 10 may be provided in a color (1) similar to or lighter than the color of the outer surface of the panel 10, and/or (2) similar to or lighter than the color of the coloring agent to be applied to the surface of the panel 10.

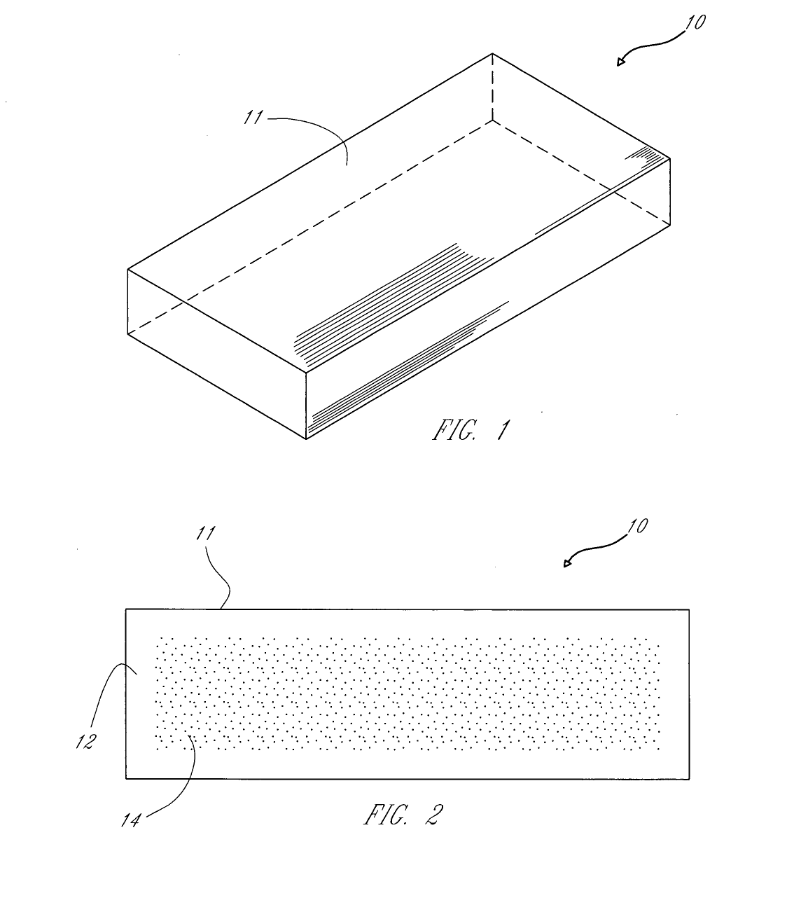

With reference to FIG. 2, a suitable panel 10 may comprise a solid core composite material having at least an outer layer 12 and a first inner layer 14. Suitably, the outer layer 12 and the first inner layer 14 of the panel 10 may be manipulated in a manner effective to produce (1) a simulated texture of a target natural wood, and (2) a simulated color of a target natural wood by absorbing into the filler component of the first inner layer 14 a color simulating amount of a coloring agent.

Herein, a suitable form of manipulation includes any abrasion means effective to form a plurality of grooves on the outer surface 11 of the panel 10. The grooves described herein may include any combination of cavities, pits, cuts, scratches, or other deformations of the outer surface 11 of the panel 10.

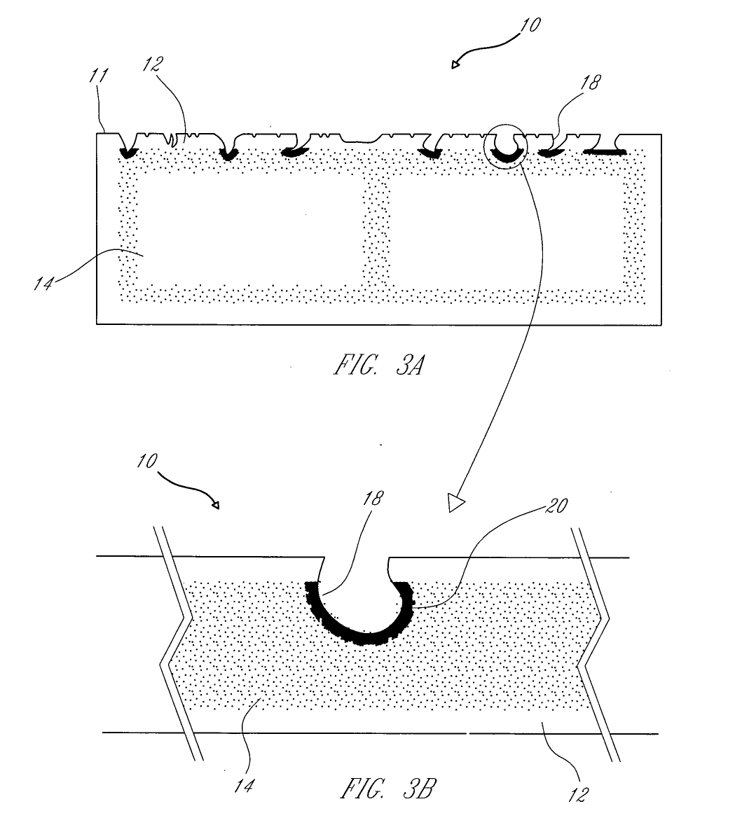

An example of a panel 10 having an abraded outer surface is illustrated in FIG. 3. In this embodiment, the panel 10 is abraded to form a plurality of grooves 18 of varying depths on the outer surface 11 of the panel 10. Suitably, the resulting outer surface 11 of the panel 10 includes a surface configuration wherein (i) a portion of the grooves 18 comprise depths effective to penetrate the first inner layer 14 exposing a portion of the filler component 16 therein, (ii) a portion of the grooves 18 comprise depths effective to penetrate the outer layer 12 only, and (iii) a portion of the outer surface 11 remains in its original state. Herein, the groove portion (i) is referred to as the exposed surface of the non-wood building material, and the groove portions (ii) and (iii) are collectively referred to as the unexposed surface of the non-wood building material.

Although not limited to a particular embodiment, a suitable matrix component may be comprised of one or more materials substantially impermeable to the coloring agent to be deposited on the outer surface 11 of the panel 10, resulting in the coloring agent being absorbed substantially by the filler component of the exposed surface—as shown in FIG. 3B. In another embodiment, the matrix component of either the exposed surface or unexposed surface may absorb the coloring agent—depending on the matrix component and/or coloring agent to be used.

In an embodiment of the non-wood building material wherein the matrix component is substantially impermeable to the coloring agent, the panel 10 suitably comprises a color variation across the outer surface 11 of the panel 10 once the coloring agent has been applied to the outer surface 11. In other words, the exposed surface adopts a color similar to the color of the coloring agent absorbed therein, while the unexposed surface maintains the color of the beginning panel 10, or in the alternative, the unexposed surface adopts a color that is lighter than the color of the exposed surface with the coloring agent absorbed therein. The result is a non-wood building material simulating the wood-grain appearance of a target natural wood.

Suitably, the matrix component of the composite material includes any material or combination of materials effective to form a panel using the melt processing methods described herein. In one embodiment, the matrix component is comprised of one or more substantially impermeable materials including but not necessarily limited to those materials resistant to chipping, cracking, excessive bending and reshaping of the panel 10 as a result of ozone, weathering, heat, moisture, and other outside mechanical and chemical influences. For example, a suitable matrix component may include any thermoplastic or thermosetting polymer or copolymer. Suitable polymeric matrices include, but are not necessarily limited to polyolefins (e.g., high density polyethylene (HDPE), low density polyethylene (LDPE), linear low density polyethylene (LLDPE), polypropylene (PP)), polyolefin copolymers (e.g., ethylene-butene, ethylene-octene, ethylene vinyl alcohol), polystyrenes, polystyrene copolymers (e.g., high impact polystyrene, acrylonitrile butadiene styrene copolymer), polyacrylates, polymethacrylates, polyesters, polyvinyl chloride (PVC), fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters and combinations thereof.

In a particularly advantageous embodiment, the matrix component of the composite material may include one or more commercially available forms of PVC. For example, a suitable PVC may include a copolymer of vinyl chloride monomer and one or more other copolymerizable monomers. The copolymer may be any type of copolymer, including but not necessarily limited to linear copolymers, block copolymers, graft copolymers, random copolymers, and regular repeating copolymers. In addition, the PVC may be combined with conventional polymer additives, including but not necessarily limited to, impact modifiers, thermal stabilizers, lubricants, plasticizers, organic and inorganic pigments, fillers, biocides, processing aids, UV inhibitors, and flame retardants. In addition, an initial pigment agent can be added to the matrix component that is effective to form a particular color on the outer surface 11 of the panel 10. One suitable initial pigment agent includes titanium dioxide, which may be effective to produce a substantially white appearance. Other initial pigment agents are herein contemplated that may produce a panel 10 having an outer surface color different than that produced by titanium dioxide, for example, a pigment agent producing a tan colored outer surface 11 of the panel 10.

Suitably, the filler component of the composite material includes any material or combination of materials effective to form a panel using the melt processing methods described herein. In one aspect, a suitable filler component may be comprised of one or more particulate based fillers effective to absorb one or more coloring agents into the panel 10. In another aspect, a suitable filler component may be comprised of one or more particulate based fillers effective to act as reinforcement in the composite material. In addition, the filler component suitably comprises a particle size and is present in an amount effective to absorb a color simulating amount of the coloring agent into at least the exposed surface. Although the particulate based filler is not necessarily limited to a particular particle size, suitable particulate based fillers may comprise a range of particle sizes common to commercially available particulate based fillers, including but not necessarily limited to a range from nano sized particles up to about 4.00 microns.

In one embodiment, the particulate based filler includes, but is not necessarily limited to an oil absorbing mineral such as, for example, a metal carbonate, ground limestone, barite, mica, talcum, clay, gypsum, silica and silicates, titanium dioxide, calcium sulphate, magnesium sulphate, and combinations thereof. Suitable metal carbonates include, but are not necessarily limited to calcium carbonate (precipitated and ground calcium carbonate) and calcium bicarbonate. In addition, the particulate based filler described herein may provide a panel sub-surface or exposed surface having a color similar to or lighter than the color of the coloring agent to be applied to the surface of the panel 10.

Suitably, the coloring agent includes any material or combination of materials effective to be readily absorbed by the one or more filler components without being readily absorbed by the matrix component of the composite material. In another embodiment, the coloring agent may include any material or combination of materials effective to be readily absorbed by both the one or more filler components and the matrix component of the composite material. Herein, a suitable coloring agent may comprise any combination of at least a solvent component, a pigment component, and a binder component. Suitable solvent components include, but are not necessarily limited to water, hydrocarbon based solvents, and combinations thereof. Suitable pigment components include, but are not necessarily limited to metallic pigments, organic pigments, and combinations thereof. Suitable binder components include, but are not necessarily limited to oils such as, for example, synthetic hydrocarbon oils, linseed oil, tung oil, white oil, naphthenic pale oil, and combinations thereof. A suitable coloring agent may also comprise one or more preservatives including for example, biocides, mildewcides and fungicides.

In a particularly advantageous embodiment, the coloring agent is absorbed by the filler component on the exposed surface in an amount effective for the non-wood building material to simulate the color of a target natural wood. In addition, the solvent component of the coloring agent may be effective to partially dissolve the polymer matrix of the matrix component following application of the coloring agent to the panel 10. In this embodiment the coloring agent is contained within the panel 10 wherein the dissolved polymer suitably forms a polymer seal over the exposed filler component once the coloring agent has been absorbed by the filler component.

Commercially available coloring agents include for example wood stain products such as: Thompson's® Water Seal™ Deck & House Oil Stain; Thompson's® Water Seal™ Deck & House Semi-Transparent Oil Stain; Thompson's® Water Seal™ Deck & House Solid Latex Stain; Thompson's® Water Seal™ Deck & House Semi-Transparent Latex Stain; Thompson's® Water Seal™ No Drip Exterior Gel Stain; Thompson's® Water Seal™ No Drip Exterior Gel Stain; Thompson's® Water Seal™ Waterproofer PLUS Tinted Wood Protector, Honey Gold; Olympic® Maximum® Semi-Transparent Stain; Olympic® Semi-Transparent Oil Stain; and Olympic® Maximum® Solid Color Stain. The coloring agents described above may be applied to the panel surface by various means including for example, by sponge, brush, sprayer, squeegee, submersion, and pouring the coloring agent over the panel.

Other additives may be present in the composite material of the non-wood building material as desired. Suitable additives include, but are not necessarily limited to process aids, lubricants, thermal stabilizers, UV stabilizers, accelerators, inhibitors, impact modifiers, fire retardant agents, biocides, pigments, viscosity depressants, and enhancers effective to modify or adjust particular properties of the composite material.

Suitable thermal stabilizers include but are not necessarily limited to dimethyl tin (under the trade name ADVASTAB ™ 181), phosphorous acid, titanium dioxide (TiO2), calcium zinc, lead salts, and combinations thereof. Suitable UV stabilizers include but are not necessarily limited to 2-hydroxy-4-n-octoxy-benzophenone (from American Cyanamid Company under the tradename Cyasorb UV 531 (“UV 531”), titanium dioxide (TiO2), and combinations thereof. Suitable impact modifiers include but are not necessarily limited to acrylic impact modifiers (ACR) and chlorinated polyethylene (CPE). Suitable lubricants include but are not necessarily limited to stearic acid, paraffin wax, mineral oil, fafty acids, and combinations thereof.

The properties of each individual panel 10, including for example the strength and stiffness of the panel 10, may depend not only on the ratio of the matrix component and the filler component, but also on the size of the particulate based fillers and the temperature of the composite material during hardening. For example, to produce a non-wood building material simulating the wood-grain appearance of a target natural wood, the matrix component is suitably present in an amount of about 60 wt. % or more, depending on the coloring agent to be used and/or the color to be simulated. In one particular embodiment, the matrix component may be present in an amount from about 70 wt. % to about 91 wt. %. In a particularly advantageous embodiment, the matrix component may be present in an amount of about 70.0 wt. %.

To effectively absorb a color simulating amount of the coloring agent in order to simulate the wood-grain appearance of a target natural wood, the filler component is suitably present in an amount of about 9.0 wt. % or more, depending on the coloring agent to be used and/or the color to be simulated. In one particular embodiment, the filler component may be present in an amount from about 9.0 wt. % to about 20 wt. %. In another embodiment, the filler component may be present in an amount from about 10.0 wt. % to about 15 wt. %. In a particularly advantageous embodiment, the filler component is present in an amount about 12.0 wt. %.

Thus, in one suitable embodiment, the non-wood building material may be comprised of the following: a matrix component comprising about 70.0 wt. %, a filler component of about 12.0 wt. %, UV stabilizer material of about 8.0 wt. %, one or more coloring agents of about 5.0 wt. %, one or more impact modifiers of about 4.0 wt. %, one or more thermal stabilizers of about 0.5 wt. %, and one or more lubricants of about 0.5 wt. %. In a particularly advantageous embodiment, the non-wood building material may be comprised of the following: a PVC matrix component comprising about 70.0 wt. %, a filler component comprising calcium carbonate of about 12.0 wt. %, UV stabilizer comprising titanium dioxide and UV 531 of about 8.0 wt. %, a coloring agent described above of about 5.0 wt. %, impact modifier comprising CPE of about 4.0 wt. %, a thermal stabilizer comprising phosphorous acid of about 0.5 wt. %, and a lubricant comprising stearic acid of about 0.5 wt. %.

As mentioned above, the overall visual appearance of the non-wood building material, including its color, may not necessarily equate to the color of the exposed surface with a coloring agent absorbed therein. Since the exposed surface adopts a color substantially similar to the color of the coloring agent, while the unexposed surface maintains a color of the beginning panel 10, or a color substantially similar thereto, it is herein contemplated that in order to blend the colors of the exposed and unexposed surfaces to simulate the wood-grain appearance of a particular target natural wood, it may be desirous to change one or more of the following features of the non-wood building material: (1) the total exposed surface of the panel; (2) the type of coloring agent used; and (3) the amount of filler component used by weight. Thus, in an embodiment wherein the unexposed surface comprises a color lighter in appearance than the color of the target natural wood to be simulated, a coloring agent that is deeper or darker in color than the color of the target natural wood to be simulated may be required in order blend the colors of the exposed and unexposed surfaces to actually simulate the wood-grain appearance of the target natural wood.

Persons skilled in this art will be able to select suitable abrasion means for texturing, i.e., forming grooves, on the outer surface 11 of the panel 10. Suitable abrasion means include, but are not necessarily limited to cabinet scrapers, gougers, planes, wire brushes, sanders such as belt sanders, woodworking sanders, plane sanders, disc sanders, a combination belt sander/wire brush/buffer grinder. In a particularly advantageous embodiment, the abrasion means is a plane sander including a wire brush configuration.

The invention will be better understood with reference to the following non-limiting examples, which are illustrative only and not intended to limit the present invention to a particular embodiment.

### EXAMPLE 1

In one non-limiting example, the steps for producing a non-wood fence picket that simulates the wood-grain appearance of a cedar fence picket are described:

STEP 1: An extruded composite panel with a partially hollow core was formed having the following dimensions: 6′ length×6″ width×¾″ height. The panel was made from PVC of about 70 wt. % having a calcium carbonate filler in a concentration of about 12 wt.%. The panel included a smooth, tan colored outer layer of PVC and a lighter colored inner layer of PVC, calcium carbonate and other additives. The panel had an outer layer of PVC of a thickness of about 0.5 mm (0.02 inches), and a first inner layer of a thickness of about 2.5 mm (0.1 inches).

STEP 2: The surface of the panel was textured by abrading the opposing surfaces of the panel with a plane sander incorporating a six strand rotating wire brush. The wire brush had varying lengths and thicknesses operationally configured to form a plurality of grooves on the surfaces of the panel. Some of the grooves penetrated the first inner layer and some of the grooves penetrated only the outer layer of the panel. The resulting groove configuration effectively removed the tan colored outer layer of PVC to expose a lighter color of the first inner layer. The resulting groove configuration also simulated the texture of cedar and was also effective to expose a desired surface area of the calcium carbonate in the first inner layer.

STEP 3: A vacuum was used to remove any leftover panel cuttings from the surface of the panel following abrasion of the panel.

STEP 4: The panel was stained by applying a coloring agent to the textured panel surface with a sponge in an amount effective to be absorbed by the exposed calcium carbonate on the surface of the portion of the grooves penetrating the first inner layer. The coloring agent comprised a commercially available wood stain including the following ingredients by wt. %:

| wt. % | Ingredient |
|---|---|
| 1.0 | Mineral Spirits |
| 27.0 | Hydrotreated Heavy Petroleum Naphtha |
| 27.0 | Light Aliphatic Hydrocarbon |
| 9.0 | Mineral Spirits 140-Flash |
| 0.1 | Ethylbenzene |
| 2.0 | Ethyltoluene |
| 0.1 | Napthalene |
| 0.5 | Tetrachloroisothalonitrile |

STEP 5: The panel was allowed to dry. A substantial portion of the coloring agent not absorbed into the panel was wiped away. The amount of the coloring agent absorbed by the calcium carbonate was a color simulating amount effective to produce a non-wood fence picket that simulated the wood-grain appearance of a cedar fence picket based on (1) the color of the stained calcium carbonate in combination with the remaining tan color of the panel surface, and (2) the groove configuration of the panel.

### EXAMPLE 2

In another non-limiting example, incorporating steps similar to Example 1 for forming a fence picket having dimensions: 6′ length×6″ width×¾″ height, a panel is provided having a total weight of about 1587.6 grams (3.50 pounds) comprising the following materials by wt. %:

| Material | Wt. % |
|---|---|
| PVC | 70 |
| Calcium Carbonate | 12 |
| UV Stabilizer | 8.0 |
| Titanium Dioxide | |
| and UV 531 | |
| Initial Pigment Agent | 5.0 |
| Impact Modifier | 4.0 |
| CPE | |
| Lubricant | 0.5 |
| Stearic Acid | |
| Thermal Stabilizer | 0.5 |
| Phosphorous Acid | |

The surface of the panel is textured wherein some of the grooves penetrate a first inner layer of the panel and some grooves penetrate only the outer layer of the panel—resulting in a panel having a total weight less than the beginning weight of the panel. Once textured, Thompson's® Water Seal™ with Tinted Wood Protector is applied to the panel surface with a sponge. The panel is allowed to dry. The coloring agent not absorbed into the panel is wiped away. The result is a non-wood fence picket having the wood-grain appearance of a cedar fence picket.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

We claim:

1. A non-wood building material having a simulated wood-grain appearance of a target natural wood comprising:
a body defined by an outer surface, the body being formed from a composite material comprising a first amount of a matrix component and a second amount of a filler component; and
a third amount of a coloring agent deposited on the outer surface of the body;
the outer surface of the body comprising a plurality of grooves configured to (1) expose filler component along the surface of the grooves, and (2) simulate the texture of the target natural wood along the outer surface of the body, the grooves defining an exposed surface of the body;
wherein the filler component is present in an amount effective to absorb the coloring agent on the exposed surface in an amount effective for the body to simulate the color of the target natural wood.

2. The non-wood building material of claim 1, wherein the matrix component is a polymer matrix.

3. The non-wood building material of claim 2, wherein the polymer matrix is selected from the group consisting of polyolefins, low density polyethylene, linear low density polyethylene, polypropylene, polyolefin copolymers, polystyrenes, polystyrene copolymers, polyacrylates, polymethacrylates, polyesters, polyvinyl chloride, fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters and combinations thereof.

4. The non-wood building material of claim 3, wherein the polymeric matrix comprises about 70 wt. % or more polyvinyl chloride.

5. The non-wood building material of claim 1, wherein the filler component comprises about 9.0 wt. % or more of a material selected from the group consisting of metal carbonate, ground limestone, barite, mica, talcum, clay, gypsum, silica and silicates, titanium dioxide, calcium sulphate, magnesium sulphate, and combinations thereof.

6. The non-wood building material of claim 5, wherein the filler component comprises from about 9.0 wt. % to about 20 wt. % calcium carbonate.

7. The non-wood building material of claim 6, wherein the filler component comprises about 12.0 wt. % calcium carbonate.

8. The non-wood building material of claim 1, wherein the coloring agent includes an oil selected from the group consisting of synthetic hydrocarbon oils, linseed oil, tung oil, white oil, naphthenic pale oil, and combinations thereof.

9. The non-wood building material of claim 2, wherein the coloring agent includes a solvent effective to partially dissolve the polymer matrix to form a polymer seal over the exposed surface once the coloring agent has been absorbed by the filler component on the exposed surface.

10. The non-wood building material of claim 1, wherein the exposed surface has a color different from the remaining surface of the body.

11. The non-wood building material of claim 1, wherein the body comprises an outer layer comprised substantially of matrix component and a first inner layer surrounded by the outer layer, the first inner layer comprising up to about 100% of the filler component dispersed within the remaining matrix component and forming a continuous phase extending throughout the first inner layer.

12. The non-wood building material of claim 11, wherein a portion of the grooves penetrate the first inner layer to expose a portion of the filler component therein.

13. The non-wood building material of claim 11, wherein a portion of the grooves penetrate the outer layer only.

14. The non-wood building material of claim 1, wherein the matrix component is substantially impermeable to the coloring agent to be deposited on the outer surface of the body.

15. A non-wood building material having a simulated wood-grain appearance of a target natural wood comprising:
a body defined by an outer surface, the body being formed from a composite material comprising a first amount of a polymer matrix component and a second amount of a filler component of about 9 wt. % or more calcium carbonate; and
a third amount of a coloring agent deposited on the outer surface of the body;
wherein at least a portion of the outer surface of the body is abraded to expose calcium carbonate in a sub-surface of the body, the abraded portion of the body simulating the texture of the target natural wood; and
wherein the coloring agent is absorbed by the calcium carbonate in the sub-surface of the body in an amount effective for the body to simulate the color of the target natural wood.

16. The non-wood building material of claim 15, wherein the polymer matrix comprises about 70 wt. % polyvinyl chloride.

17. The non-wood building material of claim 15, further comprising about 8.0 wt. % of UV stabilizer.

18. A method for producing a non-wood building material having a simulated wood-grain appearance of a target natural wood, the method comprising the following steps:
providing a body defined by an outer surface, the body being formed from a composite material including (a) a first amount of a polymer matrix component and (b) a second amount of a filler component dispersed throughout the composite material;
abrading the outer surface of the body to form a plurality of grooves on the outer surface of the body, exposing filler component on the surface of the grooves;
applying a third amount of a coloring agent to the outer surface of the body, wherein the filler component on the surface of the grooves is present in an amount effective to absorb a color simulating amount of the coloring agent;
allowing the coloring agent to reside on the outer surface of the body for a time effective for the color simulating amount of the coloring agent to be absorbed into the filler component on the surface of the grooves without the coloring agent being absorbed by the polymer matrix component; and
removing a substantial portion of the coloring agent not absorbed into the body.

19. The method of claim 18, wherein the polymer matrix comprises about 70 wt. % or more polyvinyl chloride.

20. The method of claim 18, wherein the filler component comprises from about 10.0 wt. % to about 15 wt. % calcium carbonate.
